(19) United States
(12) Patent Application Publication
(10) Pub. No.: US 2017/0017890 A1
(43) Pub. Date: Jan. 19, 2017

(54) Method and System For Identifying Potentially Successful Dating Relationship

(71) Applicant: Jewel Dohan, Lady Lake, FL (US)

(72) Inventor: Jewel Dohan, Lady Lake, FL (US)

(21) Appl. No.: 15/210,878

(22) Filed: Jul. 14, 2016

Related U.S. Application Data
(60) Provisional application No. 62/192,562, filed on Jul. 14, 2015.

(51) Int. Cl. G06N 5/04; G06N 99/00; H04L 29/08

(52) U.S. Cl. CPC G06N 5/048; H04L 67/306; G06N 99/005

(57) ABSTRACT

A method for identifying people who are potentially to have a successful dating relationship including embedding an application within a mobile computing device, having at least a first user and a second user to sign in into each's respective mobile device application to initiate a session; allowing the application to generate a question to the first user and the second user; deciding either the first user or the second user is in command mode; answering the question with response to each other by the first user and the second user; allowing the first user or the second user in command mode to decide if the received response is satisfactory; moving the first user or the second user forward or backward from an end point depending on whether the response is satisfactory.

### INCORPORATION BY REFERENCE

This application claims the benefit of priority under 35 U.S.C. 119(e) to the filing date of U.S. provisional patent application No. 62/293,562 “System, Apparatus and Method of Creating an Online Game of Dating, Love and Relationship” which was filed on Jul. 14, 2015 and which are incorporated herein by reference in their entirety.

### FIELD OF INVENTION

The present invention is directed generally to a system, apparatus and method of creating a mobile smartphone application game of dating, love, and relationship for smartphone devices.

### BACKGROUND OF THE INVENTION

The present invention relates to systems, apparatuses and methods of creating a mobile smartphone application game.

It is known men and women like to participate in games with each other since the beginning of time. During the games, they create an exciting atmosphere of direct rapport and communication whether they have known each other for years or just met.

Games, in which players ask and answer questions directly and honestly, are fun. People get to know how the other person really feels. Even if players answer the questions according to what they think other participants would like to hear, the game becomes a strategy game, and is still fun and challenging.

### OBJECTIVE OF THE INVENTION

Since the beginning of time, every man and woman has always wanted to know “what is the opposite sex thinking?” The Love Steps game really lets people find out “who is this person, and what are they really about” in a unique fun and exciting game.

Accordingly, it is the object of the invention to provide men and women with a mobile smartphone application game that facilitates asking and answering questions in order to create an exciting atmosphere of direct rapport and communication.

It is also the object of this invention to facilitate men and women getting to know each other in a fun and challenging way.

### SUMMARY OF THE INVENTION

In one aspect of the invention, a method for identifying people who are potentially to have a successful dating relationship comprising embedding an application within a mobile computing device, the method comprising: having at least a first user and a second user to sign in into each's respective mobile device application to initiate a session; allowing the application to generate a question to the first user and the second user; deciding either the first user or the second user is in command mode; answering the question with response to each other by the first user and the second user; allowing the first user or the second user in command mode to decide if the received response is satisfactory; moving the first user or the second user forward or backward from an end point depending on whether the response is satisfactory.

In one embodiment, the method further comprises showing the gap between the end point and the first user or the second user. In one embodiment, the method further comprises showing the movement of the first user or the second user moving towards or away from the end point. In one embodiment, the method further comprises showing the gap between the end point and the first user or the second user. In one embodiment, the method further comprises showing the gap between the end point and the first user or the second user.

In one embodiment, the first user and the second user be in command mode in alternate sequence. In one embodiment, the identities of the first user and the second user are not revealed to each other until both have reached to the end point. In one embodiment, the identities of the first user and the second user are not revealed to each other until at least either the first user or the second user has reached to the end point. In one embodiment, the session is terminated when the identities are revealed. In one embodiment, the session is terminated when the first user or the second user do not reach to the end point within a predetermined number of questions. In one embodiment, session is terminated when both the first user and the second user do not reach to the end point within a predetermined number of questions.

In another aspect of the invention, a mobile computer device for identifying people who are potentially to have a successful dating relationship comprising an application embedded within the mobile device, the application comprising: a sign-in module which in operation allows at least a first user and a second user to sign in from each's respective mobile device to initiate a session; a question generation module which in operation generates question to the first user and the second user; a sequence module which in operation decides either the first user or the second user is in command mode; answer module which in operation allow the first user and the second user to provide answer to each other; a command response module which in operation allows the first user or the second user in command mode to decide if answer received is satisfactory; a progress module which in operation moves either the first user or the second user forward and toward an end point or backward and away from the end point in response to whether the answer is satisfactory.

In one embodiment, the application further compresses a map module where in operation the map module provides visual representation of the forward movement and the backward movement of the first user and the second user. In one embodiment, the application further compresses a map module where in operation the map module provides visual representation the distance between the final destination and the first user or the second user.

In one embodiment, the application further compresses a map module where in operation the map module provides visual representation of the forward movement and the backward movement of the first user and the second user. In one embodiment, the sequence module alternates in sequence between the first user and the second user. In one embodiment, the identities of the first user and the second user are not revealed to each other until both have reached the end point.

In one embodiment, the application is hosted by a computer server wirelessly connected to the first user and the second user's mobile devices. In one embodiment, the application further compresses a map module where in operation the map module provides visual representation of the forward movement and the backward movement of the first user and the second user. In one embodiment, the identities of the first user and the second user are not revealed to each other until either one has reached the end point.

In one embodiment, the application further compresses a termination module where in operation the termination module provides terminates the session if both the first user or the second user do not reach to the end point within a predetermined number of questions. In one embodiment, the application further compresses a termination module where in operation the termination module terminates the session if both the first user or the second user do not reach to the end point within a predetermined number of questions.

In one embodiment, the application further compresses a termination module where in operation the termination module terminates the session if either the first user or the second user does not reach to the end point within a predetermined number of questions. In one embodiment, the application further compresses a termination module where in operation the termination module terminates the session if either the first user or the second user does not reach to the end point within a predetermined number of questions. In one embodiment, the progress module moves the first user or the second user forward or backward based on a predetermined metric in connection to the generated questions.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is an example of one game board design, which may be animated and displayed within the smartphone app.

FIG. 2 is an example of the left side of a game board design, which may be animated and displayed within the smartphone app.

FIG. 3 is an example of the right side of a game board design, which may be animated and displayed within the smartphone app.

FIG. 4 illustrates one embodiment of the main menu screen, which may be animated and displayed within the smartphone app.

FIG. 5 illustrates one embodiment of the player-loading screen, which displays each player's profile and name.

FIG. 6 illustrates one embodiment of the settings screen.

FIG. 7 illustrates one embodiment of a screen where player's answers to the specific question are revealed and judged.

FIG. 8 illustrates how players access the Love Steps game using smartphones with Internet access.

FIG. 9 illustrates one embodiment of a game-flow diagram.

FIG. 10 illustrates one embodiment of an animated screen that displays when a player reaches the Love Door.

FIG. 11 illustrates one embodiment of player's game pieces on the Love Steps game board that may be displayed whenever a player's game piece advances or retreats.

FIG. 12 illustrates one embodiment of the question screen, which player's interact with to submit their answers via text, audio, or video.

FIG. 13 illustrates one embodiment of the opening screen where player's must log in to continue to the main screen.

FIG. 14 is one possible wire frame representation, illustrating the flow of the mobile game, screen by screen.

### DETAILED DESCRIPTION OF THE INVENTION

LoveSteps™ game is played by at least two people; usually, a man and a woman. The game is played with male and female questions. Both players answer a pop-up question, but take turns to display his or her answer. The other player whose answer is not displayed would check the answers. If the answers are in tune, or on the same wavelength, she or he advances the other player so many spaces toward the Love Door or out the Front Door.

In one embodiment of the game, a mobile smartphone application is created with a graphical representation of a stage with a Love Door and Front Door. It is appreciated that the stage can be replaced with a living room or family room in other embodiments. The stage is furnished with a sofa set, in one embodiment, where the players' avatars sit. The questions pop up on the screens. Both partners simultaneously type in their answers. However, only one answer is shown first. The player whose answer was not displayed reads the displayed answer, checks it against his or her own answer, and then makes a decision to advance, or retreat the other player. Only after this decision is made, the hidden answer is displayed. This feature is fun, because it allows both partners to find out what the other person's answer, and thought, before his or her decision to advance or retreat his/her partner.

In one embodiment, the players' avatars are sitting at the sofa set as if they are physically interacting with each other, and posting love, dating, and/or relationship questions to each other. Holograms of the avatars would be advanced to the Love Door, or retreated to the Front Door to show the progress of the game.

In one embodiment, if someone is pushed toward the front door, the next round he or she has an option to make up one's own question as a kind of “comeback” or just an option to progress with the game. This exciting feature further engrosses and personalizes the players' rapport.

In one embodiment the animated board will be splashed on the screen informing the users of their progress towards the “Love Door.” This is both dramatic and exciting, like a scoreboard, which allows them to see how close they are getting to that “Love Door.”

In one embodiment, Love Steps is also available as a Video Game, which can be played with two people in any commercial location desired through the use of smartphone computing devices with the Love Steps mobile application.

LoveSteps™ questions may be, but are not limited to, the following:

In one embodiment, the smartphone game is for all age groups, even a group of 50+ seniors. Players will go to the website where they can decide to play the “smartphone or interne” game. Players decide if they want to type their answers, speak their answers, or record a video of their answers.

In one embodiment of the smartphone application instructions may include, but are not limited to, the following:
1) “Be ready for Fun! You're going from the FRONT DOOR to the LOVE DOOR!
2) “ROLL THE DICE! High Number Starts the Game.”
3) A question is selected and displayed.
4) Both male and female players answer the question at the same time by text, audio recording, or video recording.
5) The answer and the user's reason for it are displayed, but only after both answers have been submitted.
   a. Example Question: “If a Man tells you he does not want to get involved, should you believe him? (Correct=Advance 3 Spaces, Incorrect=Retreat 2 Spaces)
   b. Sample Answer #1: “Yes, because he knows himself better than you.
   c. Sample Answer #2: “No, because he may just fear rejection.”
6) If the Female is first, she READS the Male answer and decides if she wants to advance him toward the LOVE DOOR or back toward the FRONT DOOR.
7) Now the Male gets to see what the Female really answered. It may be completely different than what he expected. All that matters is she “liked” what he said . . . so she advanced him toward the LOVE DOOR! Or, in the alternative, she “did not like” what he said . . . so she sent him back toward the FRONT DOOR!
8) Next, another question pops up . . . and this time the Male decides to advance her or send her back.
9) That's it! Repeat this process until either the Male or Female reaches the LOVE DOOR, or FRONT DOOR. The fun is you never know what the other person may be thinking . . . But you do get to see what they wrote!
10) “What happens when you get to the LOVE DOOR? That's up to you! But you sure are going to know more about HOW the other player thinks than you ever thought possible.”
11) “LOVE STEPS is Fun and Unique!”

### DETAILED DESCRIPTION OF THE DRAWINGS

The invention will be described in the context of a preferred embodiment.

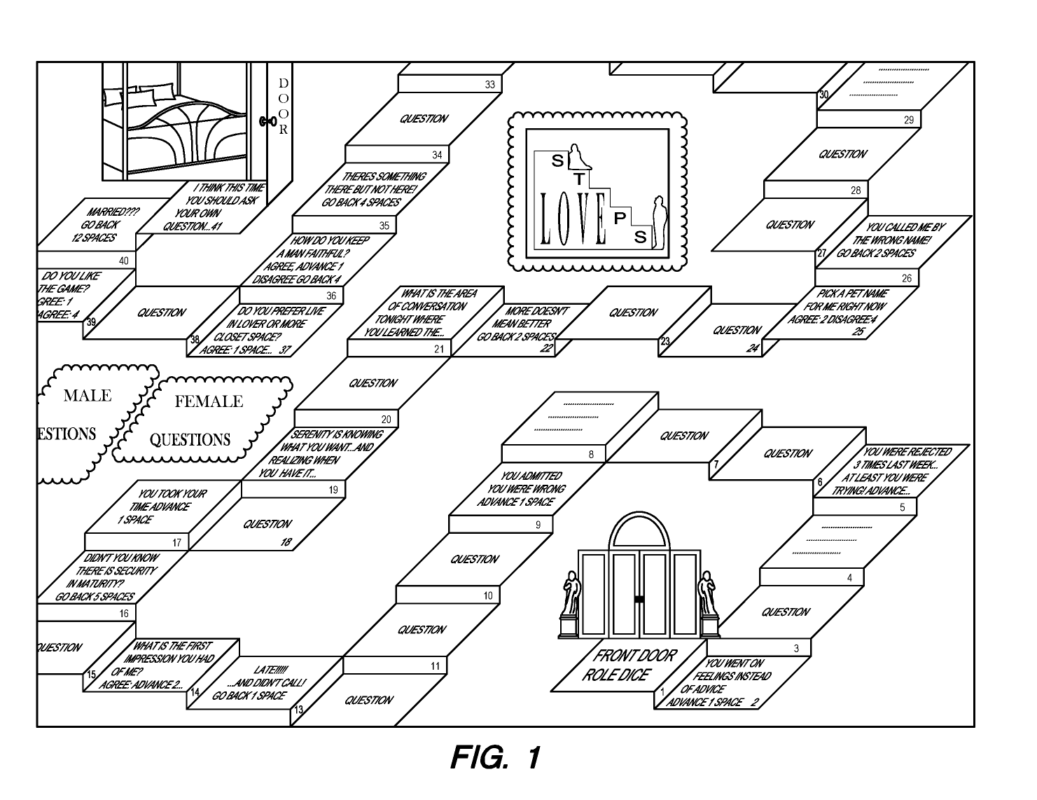

Referring to FIG. 1, this illustrates one embodiment of the game board design, which may be animated and displayed within the smartphone app. This game board may be animated with player pieces that advance or retreat from the “FRONT DOOR” to the “LOVE DOOR” whereupon the player wins the game.

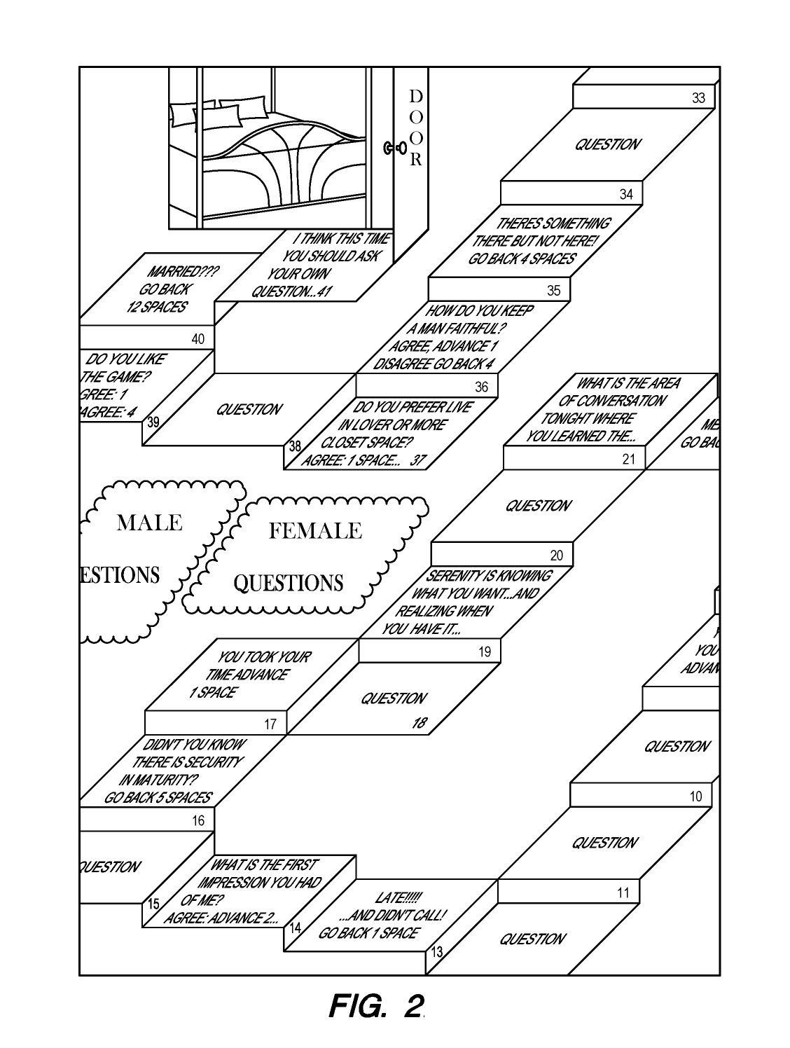

Referring to FIG. 2, this is an example of the left side of a game board design, which may be animated and displayed within the smartphone app. This side of the game board may be animated, isolated, and zoomed in upon to show the progress of player pieces as they advance towards or retreat from the “LOVE DOOR.”

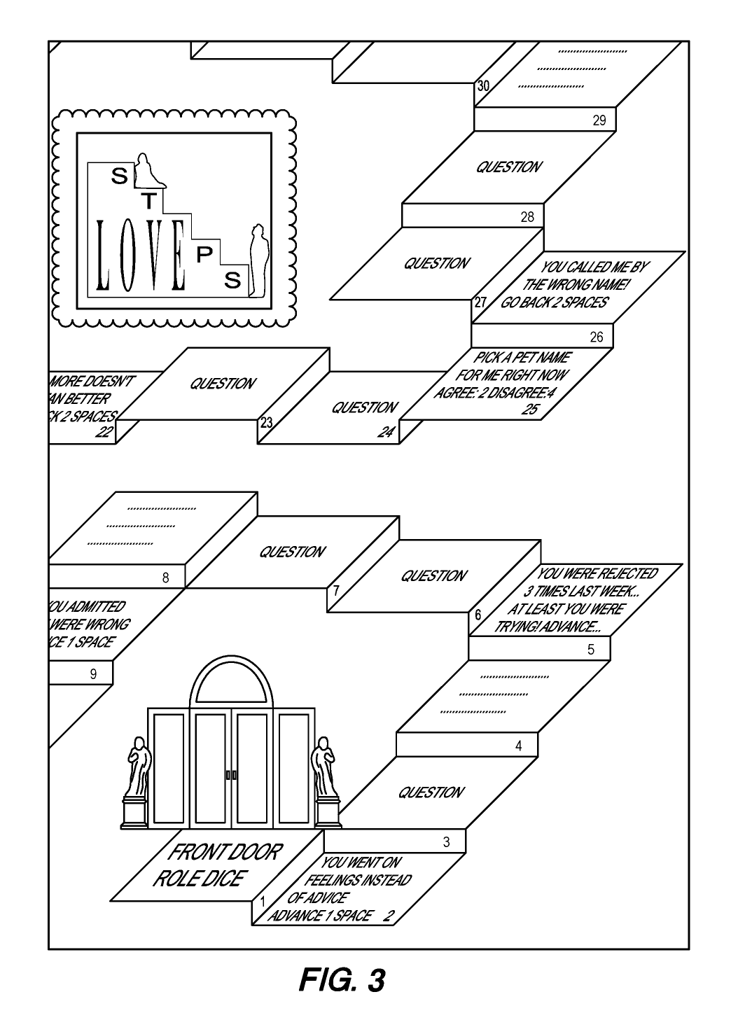

Referring to FIG. 3, this is an example of the right side of a game board design, which may be animated and displayed within the smartphone app. This side of the game board may be animated isolated and zoomed in upon to show the progress of player pieces as they advance or retreat towards from the “FRONT DOOR.”

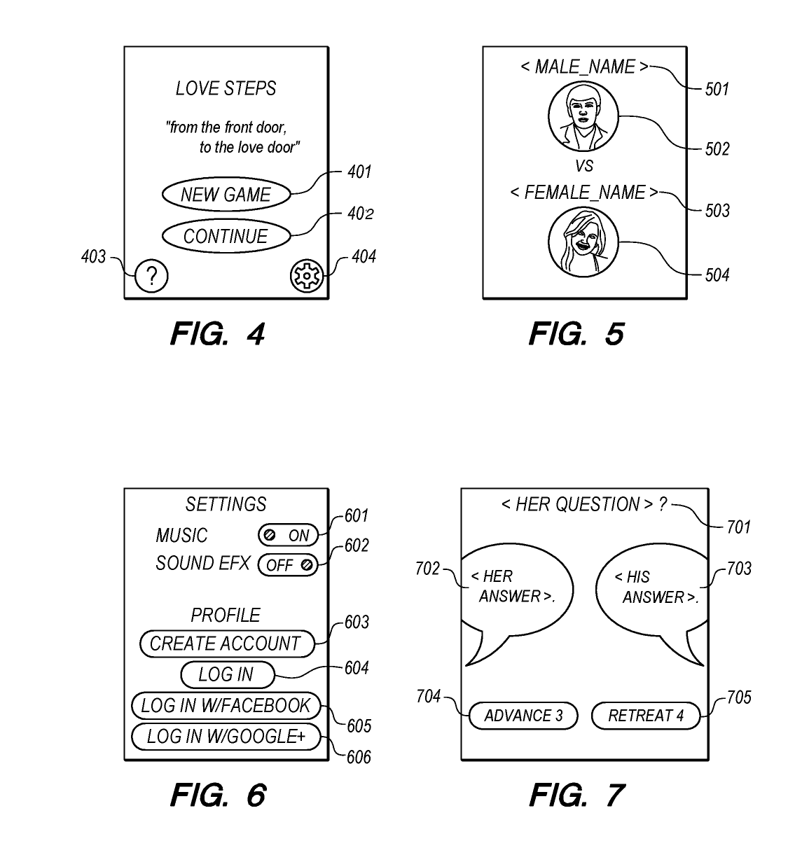

Referring to FIG. 4, this illustrates an embodiment of the smartphone application “LOVE STEPS” main menu screen. Here, the game logo is displayed and users may interact with the game by creating a new game 401, or continue 402 a previous game. Players may also select the information 403 button, which will direct them to the information screen. Players may also select the settings button 404, which will direct them to the settings screen.

Referring to FIG. 5, this illustrates an embodiment of the player selection where each player's profile and name are displayed to introduce the players to each other. Here in this embodiment, a male's name 501 (player 1) is displayed directly above his profile picture 502, which may also be animated. Also in this embodiment, a female's name 503 (player 2) is displayed directly above her profile picture 504, which may also be animated.

Referring to FIG. 6, this illustrates an embodiment of the settings screen, where a user may select from various user preferences. Such preferences may include but are not limited to music 601, sound effects 602, or profile preferences. A user may also create a new account 603, log in 604 if not having done so at the opening screen, or per user preference, may log in using Facebook 605, or Google+ 606 whereupon a users profile picture, name and other information will be imported to automatically create an account.

Referring to FIG. 7, this illustrates an embodiment of the screen where each player's answer is revealed to the other. Here, the question may be displayed on the top of the screen 701. Below this may be displayed each player's answer 702, 703 for the other player to see. If it is the female's turn, it will be up to her discretion whether or not to advance 704 or retreat 705 the male player.

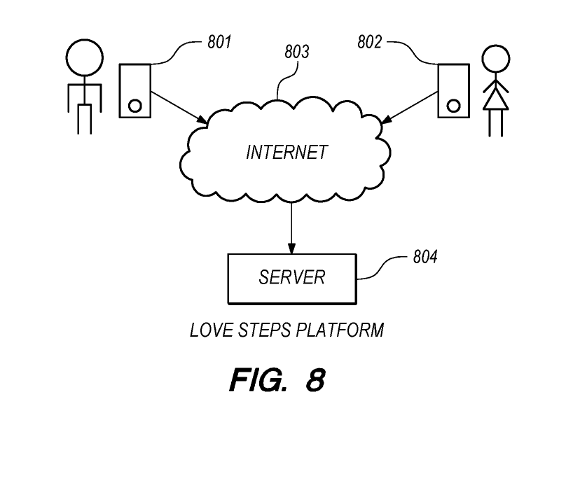

Referring to FIG. 8, this illustrates an embodiment of how players engage each other using smartphones capable of downloading the mobile application 801, 802. The server 804 hosting the Love Steps Platform connects to users via the Internet 803.

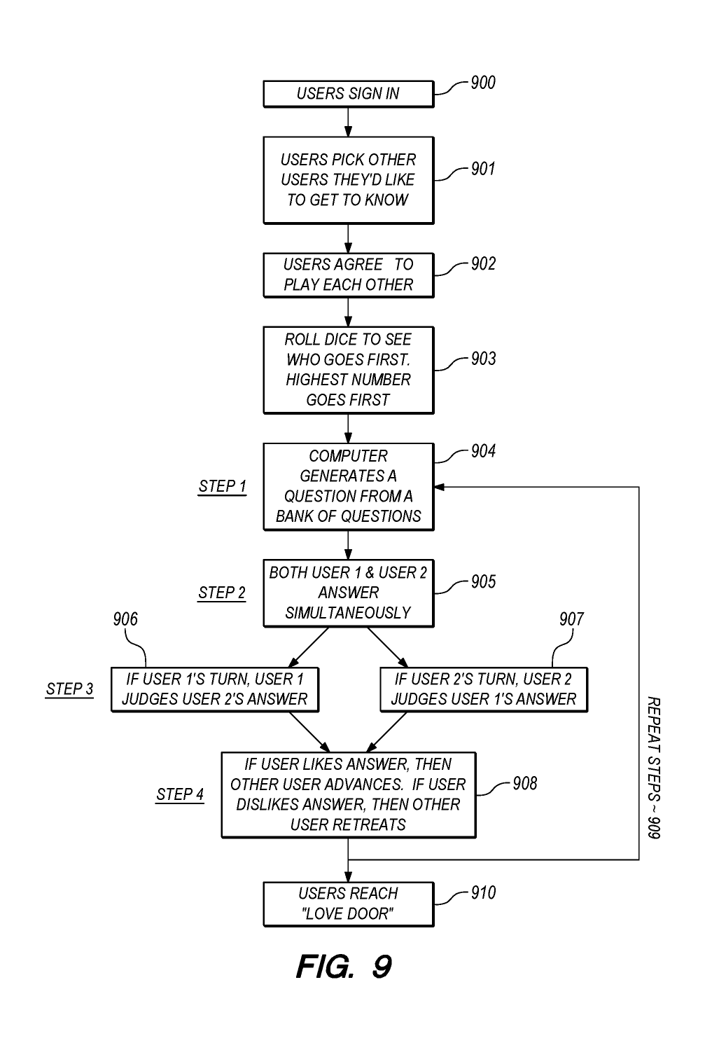

Referring to FIG. 9, this illustrates an embodiment of the wireframe of the game flow, screen by screen. The user first signs in 900, users select other players they would like to get to know 901, users agree or disagree to play other players 902, the players roll the dice to decide who goes first (highest number goes first) 903, whereupon the computer generates a question from a pre-generated list of questions 904, both players see the question and answer within 30 seconds 905. If it is player one's turn, he or she judges the other players answer 906 and either advances or retreats 908 the other players position piece on the game map. If it is player two's turn, he or she judges the other players answer 907 and either advances or retreats 908 the other player's position piece on the game map. Steps 1 through 4 are repeated 909 until either player reaches the Love Door 910.

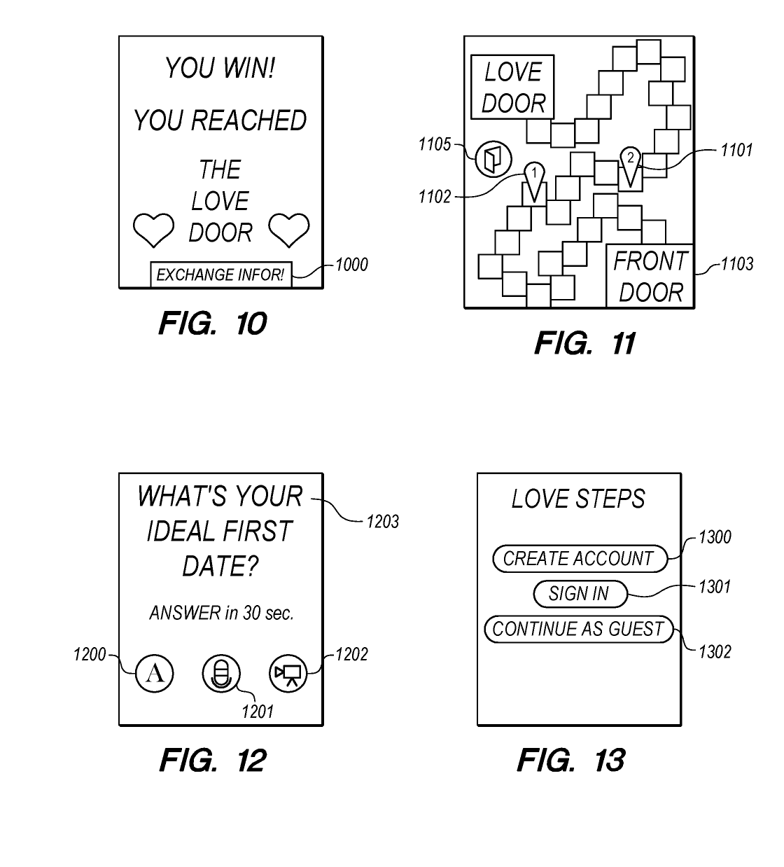

Referring to FIG. 10, this illustrates an embodiment of the screen to be displayed to the player who reaches the Love Door. A player may elect to exchange his or her information at this point to the other party 1000.

Referring to FIG. 11, this illustrates an embodiment of the game board that may be animated with each player's position piece 1101, 1102 as they advance through the game towards the Love Door 1104 or the Front Door 1105. Here, if a player feels uninterested in continuing the game, she may he or she may elect to exit the game by selecting the exit button 1105.

Referring to FIG. 12, this illustrates an embodiment of the question screen that is displayed to each player to be answered. The question is presented 1203, whereupon each player has 30 seconds to answer the question. This may be done by texting 1200, recording audio 1201, or recording video 1202.

Referring to FIG. 13, this illustrates an embodiment of the opening screen whereupon a user may create an account 1300, Sign in with a previously created account 1301, or continue as guest 1302 if they prefer.

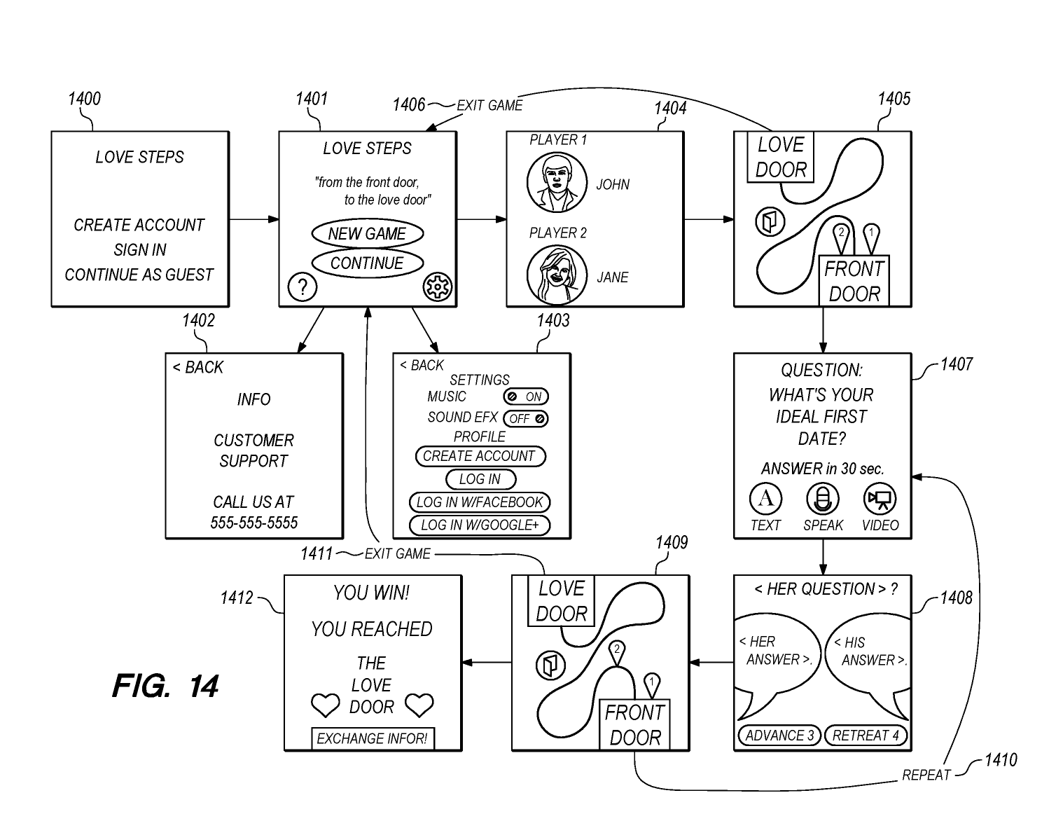

Referring to FIG. 14, this illustrates an embodiment of the wire-frame progression of the game, screen by screen. First, opening screen 1400 proceeds to the main menu 1401, which may proceed to the info screen 1402 or the settings screen 1403. The main menu 1401 may also proceed to the player selection and introduction screen 1404. From here the game begins and the board is displayed with each player's position piece 1405. A player may also elect to exit the game 1406, which takes them to the main menu 1401. From there, the computer randomly selects via dice roll which player goes first, and generates a question, which it presents to each player to be answered 1407. Then, the answers are revealed to each player and depending on whose turn it is, the answers are judged, and each player is advanced or retreated 1408 the displayed number of spaces. The game board is displayed again showing each players progress 1409. Once again, a player may exit the game 1411 and return to the main menu per their preference. This process is repeated 1410 until one player reaches the Love Door whereupon the final screen 1412 is displayed informing the player of his victory and is given the chance to exchange information with the other player in order to contact them personally.

1. A method for identifying people who are potentially to have a successful dating relationship comprising embedding an application within a mobile computing device, the method comprising:
i) having at least a first user and a second user to sign in into each's respective mobile device application to initiate a session;
ii) allowing the application to generate a question to the first user and the second user;
iii) deciding either the first user or the second user is in command mode;
iv) answering the question with response to each other by the first user and the second user;
v) allowing the first user or the second user in command mode to decide if the received response is satisfactory;
vi) moving the first user or the second user forward or backward from an end point depending on whether the response is satisfactory.

2. The method of claim 1 wherein the method further comprises showing the gap between the end point and the first user or the second user.

3. The method of claim 1 wherein the method further comprises showing the movement of the first user or the second user moving towards or away from the end point.

4. The method of claim 1 wherein the method further comprises showing the gap between the end point and the first user or the second user.

5. The method of claim 1 wherein the method further comprises showing the gap between the end point and the first user or the second user.

6. The method of claim 1 wherein the first user and the second user be in command mode in alternate sequence.

7. The method of claim 1 wherein the identities of the first user and the second user are not revealed to each other until both have reached to the end point.

8. The method of claim 1 wherein the identities of the first user and the second user are not revealed to each other until at least either the first user or the second user has reached to the end point.

9. The method of claim 7 wherein the session is terminated when the identities are revealed.

10. The method of claim 1 wherein the session is terminated when the first user or the second user do not reach to the end point within a predetermined number of questions.

11. The method of claim 1 wherein the session is terminated when both the first user and the second user do not reach to the end point within a predetermined number of questions.

12. A mobile computer device for identifying people who are potentially to have a successful dating relationship comprising an application embedded within the mobile device, the application comprising:
i) a sign-in module which in operation allows at least a first user and a second user to sign in from each's respective mobile device to initiate a session;
ii) a question generation module which in operation generates question to the first user and the second user;
iii) a sequence module which in operation decides either the first user or the second user is in command mode;
iv) answer module which in operation allow the first user and the second user to provide answer to each other;
v) a command response module which in operation allows the first user or the second user in command mode to decide if answer received is satisfactory;
vi) a progress module which in operation moves either the first user or the second user forward and toward an end point or backward and away from the end point in response to whether the answer is satisfactory.

13. The mobile computer device of claim 12 wherein the application further compresses a map module where in operation the map module provides visual representation of the forward movement and the backward movement of the first user and the second user.

14. The mobile computer device of claim 12 wherein the application further compresses a map module where in operation the map module provides visual representation the distance between the final destination and the first user or the second user.

15. The mobile computer device of claim 12 wherein the application further compresses a map module where in operation the map module provides visual representation of the forward movement and the backward movement of the first user and the second user.

16. The mobile computer device of claim 12 wherein the sequence module alternates in sequence between the first user and the second user.

17. The mobile computer device of claim 12 wherein the identities of the first user and the second user are not revealed to each other until both have reached the end point.

18. The mobile computer device of claim 12 wherein the application is hosted by a computer server wirelessly connected to the first user and the second user's mobile devices.

19. The mobile computer device of claim 12 wherein the application further compresses a map module where in operation the map module provides visual representation of the forward movement and the backward movement of the first user and the second user.

20. The mobile computer device of claim 12 wherein the identities of the first user and the second user are not revealed to each other until either one has reached the end point.

21. The mobile computer device of claim 12 wherein the application further compresses a termination module where in operation the termination module provides terminates the session if both the first user or the second user do not reach to the end point within a predetermined number of questions.

22. The mobile computer device of claim 12 wherein the application further compresses a termination module where in operation the termination module terminates the session if both the first user or the second user do not reach to the end point within a predetermined number of questions.

23. The mobile computer device of claim 12 wherein the application further compresses a termination module where in operation the termination module terminates the session if either the first user or the second user does not reach to the end point within a predetermined number of questions.

24. The mobile computer device of claim 12 wherein the application further compresses a termination module where in operation the termination module terminates the session if either the first user or the second user does not reach to the end point within a predetermined number of questions.

25. The mobile computer device of claim 12 wherein the progress module moves the first user or the second user forward or backward based on a predetermined metric in connection to the generated questions.
